(19) United States
(12) Patent Application Publication
(10) Pub. No.: US 2025/0282116 A1
(43) Pub. Date: Sep. 11, 2025

(54) SHEET COMPRISING THERMAL INSULATION LAYER AND ADHESIVE LAYER

(71) Applicant: Resonac Corporation, Tokyo (JP)

(72) Inventors: Nozomi MATSUBARA, Tokyo (JP); Yoshihiro TSUDA, Tokyo (JP); Hiroshi YOKOTA, Tokyo (JP); Tomoko HIGASHIUCHI, Tokyo (JP); Naoki FURUKAWA, Tokyo (JP); Tetsuya TANIGUCHI, Tokyo (JP); Kazunori SAKUMA, Tokyo (JP)

(21) Appl. No.: 18/859,951

(22) PCT Filed: Jun. 14, 2023
(86) PCT No.: PCT/JP2023/022120

§ 371 Date: Oct. 24, 2024

(30) Foreign Application Priority Data
Jun. 21, 2022 (JP) 2022-099812

(51) Int. Cl. B32B 5/16; B32B 7/12

(52) U.S. Cl. CPC B32B 5/16; B32B 7/12; B32B 2307/304

(57) ABSTRACT

A sheet including a thermal insulation layer and an adhesive layer, in which the thermal insulation layer contains first hollow particles being thermally expandable organic hollow particles, second hollow particles being organic hollow particles other than the first hollow particles, and a matrix polymer.

### TECHNICAL FIELD

The present invention relates to a sheet including a thermal insulation layer and an adhesive layer.

### BACKGROUND ART

Non-volatile memories, which are characterized by low power consumption and high-speed reading and writing, are attracting attention as next-generation memories. For example, phase change memory (PCM), magnetoresistive memory (MRAM), and resistance change memory (ReRAM) are known. Non-volatile memories are susceptible to heat, and maintaining the quality when the non-volatile memories are exposed to a high-temperature environment in a reflow step during mounting has been an issue.

With regard to this issue, for example, Patent Literature 1 discloses a method for manufacturing a magnetic recording device, the method including a reflow step having: a first step of providing a thermal insulation material on a surface of a magnetic recording device, the surface being exposed in a reflow furnace; a second step of passing the magnetic recording device provided with the thermal insulation material through a reflow furnace and heating the magnetic recording device; and a third step of removing the thermal insulation material from the magnetic recording device heated in the second step.

### CITATION LIST

### Patent Literature

Patent Literature 1: Japanese Unexamined Patent Publication No. 2017-224663

### SUMMARY OF INVENTION

### Technical Problem

The inventors of the present invention designed a sheet that includes a thermal insulation layer containing organic hollow particles and a matrix polymer, and an adhesive layer, as a thermal insulation material to be used during a reflow step. However, it has been revealed that when the sheet is exposed to a high-temperature environment (for example, 180° C. or higher) in the reflow step, the organic hollow particles contained in the sheet may shrink, and as a result, thermal insulation properties of the sheet may deteriorate.

Thus, an object of an aspect of the present invention is to provide a sheet in which the deterioration of thermal insulation properties when exposed to a high-temperature environment can be suppressed.

### Solution to Problem

The present inventors conducted intensive studies, and as a result, the inventors found that with regard to a sheet including a thermal insulation layer and an adhesive layer, when the thermal insulation layer contains both thermally expandable organic hollow particles and hollow particles other than thermally expandable organic hollow particles, deterioration of thermal insulation properties when the sheet is exposed to a high-temperature environment can be suppressed. According to some aspects, the present invention provides the following [1] to [4].
[1]A sheet including:
a thermal insulation layer; and
an adhesive layer,
wherein the thermal insulation layer contains first hollow particles being thermally expandable organic hollow particles, second hollow particles being organic hollow particles other than the first hollow particles, and a matrix polymer.
[2] The sheet according to [1], wherein a content of the first hollow particles is 1.5% by volume or more based on a total volume of the thermal insulation layer.
[3] The sheet according to [1] or [2], wherein a volume ratio of a content of the second hollow particles to a content of the first hollow particles is 45 or less.
[4] The sheet according to any one of [1] to [3], wherein the matrix polymer contains a compound represented by the following Formula (1) as a monomer unit:

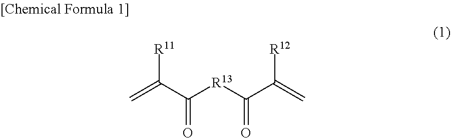

[in the Formula (1), R¹¹ and R¹² each independently represent a hydrogen atom or a methyl group; and R¹³ represents a divalent group having a polyoxyalkylene chain.]

### Advantageous Effects of Invention

According to an aspect of the present invention, a sheet in which the deterioration of thermal insulation properties when exposed to a high-temperature environment is suppressed can be provided.

### BRIEF DESCRIPTION OF DRAWINGS

FIG. 1 is a schematic cross-sectional view illustrating an embodiment of a sheet.

### DESCRIPTION OF EMBODIMENTS

Embodiments of the present invention will be described in detail below. Incidentally, the present invention is not intended to be limited to the following embodiments.

The term “(meth)acryloyl” in the present specification means “acryloyl” and “methacryloyl” corresponding thereto, and the same also applies to similar expressions such as “(meth)acrylate” and “(meth)acryl”.

The weight average molecular weight (Mw) according to the present specification means a value measured by using gel permeation chromatography (GPC) under the following conditions and determined by using polystyrene as a standard substance.
Measuring instrument: HLC-8320GPC (product name, manufactured by Tosoh Corporation)
Analytical column: TSKgel SuperMultipore HZ-H (three pieces connected together) (product name, manufactured by Tosoh Corporation)
Guard column: TSKguardcolumn SuperMP (HZ)-H (product name, manufactured by Tosoh Corporation)
Eluent: THF
Measurement temperature: 25° C.

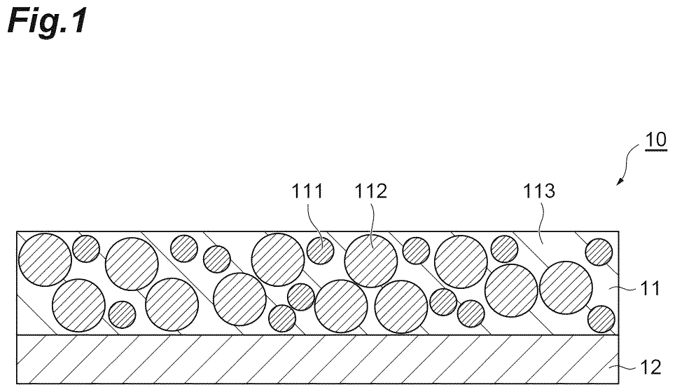

FIG. 1 is a schematic cross-sectional view illustrating an embodiment of a sheet. The sheet 10 shown in FIG. 1 includes a thermal insulation layer 11 and an adhesive layer 12. The thermal insulation layer 11 and the adhesive layer 12 may be laminated so as to be in contact with each other.

The thermal insulation layer 11 contains first hollow particles 111, which are thermally expandable organic hollow particles, second hollow particles 112, which are organic hollow particles other than the first hollow particles, and a matrix polymer 113.

The first hollow particles 111 each have an outer shell and a hollow portion. The first hollow particles 111 are organic hollow particles that expand due to heat (thermally expandable). The thermally expandable organic hollow particles according to the present specification are organic hollow particles whose maximum volumetric expansion ratio with respect to the volume at 25° C. is 10 times or more. When the thermal insulation layer 11 contains the first hollow particles 111, even when the second hollow particles 112 that will be described below shrink in the reflow step, and the volume of the hollow portion decreases, the first hollow particles 111 expand due to heat, resulting in an increase in the volume of the hollow portion. Therefore, a decrease in the volume of the hollow portion of the hollow particles contributing to thermal insulation properties in the thermal insulation layer 11 as a whole can be suppressed. As a result, deterioration of thermal insulation properties of the thermal insulation layer 11 (sheet 10) can be suppressed.

The maximum volumetric expansion ratio of the first hollow particles 111 is measured as the ratio between the maximum volume of the first hollow particles 111 and the volume at 25° C. (maximum volume/volume at 25° C.) when the temperature is increased at a temperature increase rate of 10° C./min in thermomechanical analysis (TMA). The maximum volumetric expansion ratio of the first hollow particles 111 may be, for example, 20 times or more, 30 times or more, or 40 times or more, and may be 120 times or less.

The outer shell of the first hollow particles 111 is composed of an organic material. The outer shell of the first hollow particles 111 is preferably composed of a polymer, and is more preferably composed of a thermoplastic polymer. In this case, since the outer shell is softened by heating, even when the liquid enclosed in the hollow portion vaporizes, and the internal pressure increases, the hollow particles are less likely to crack, and the hollow particles expand easily. The thermoplastic polymer may be, for example, a polymer containing acrylonitrile, vinylidene chloride, or the like as a monomer unit. The thickness of the outer shell may be 2 μm or more and may be 15 μm or less.

In the hollow portion of the first hollow particles 111, for example, a liquid is enclosed. The first hollow particles 111 enclose, for example, a liquid at normal temperature and normal pressure (for example, at least at atmospheric pressure and 30° C.). This liquid is appropriately selected, for example, according to the heating temperature in the reflow step and the shrink initiation temperature of the second hollow particles 112 that will be described below. The liquid is, for example, a liquid that vaporizes at a temperature equal to or lower than the highest heating temperature in the reflow step. The liquid may be a liquid that vaporizes at a temperature equal to or lower than the shrink initiation temperature of the second hollow particles 112. The liquid may be, for example, a hydrocarbon having a boiling point (at atmospheric pressure) of 50° C. or higher, 100° C. or higher, 150° C. or higher, or 200° C. or higher. In the hollow portion of the first hollow particles 111, a gas may be further enclosed in addition to the above-described liquid.

Examples of the component enclosed in the hollow portion of the first hollow particles 111 include hydrocarbons such as propane, propylene, butene, normal butane, isobutane, normal pentane, isopentane, neopentane, normal hexane, isohexane, heptane, isooctane, normal octane, isoalkane (number of carbon atoms: 10 to 13), and petroleum ether; low-boiling point compounds such as methane halides and tetraalkylsilanes; and compounds that are gasified by thermal decomposition, such as azodicarbonamide.

The average particle size of the first hollow particles 111 may be 5 μm or more, or 10 μm or more, and may be 50 μm or less, 40 μm or less, or 30 μm or less. The average particle size of the first hollow particles 111 is measured by a laser diffraction and scattering method (for example, using “SALD-7500nano” manufactured by SHIMADZU CORPORATION).

From the viewpoint that the sheet 10 is more suitably used as a thermal insulation material in the reflow step (generally heated up to 260° C.), the expansion initiation temperature of the first hollow particles 111 is preferably equal to or lower than the shrink initiation temperature of the second hollow particles 112 that will be described below. The expansion initiation temperature of the first hollow particles 111 is preferably 150° C. or higher or 180° C. or higher, and is preferably 260° C. or lower, 240° C. or lower, 220° C. or lower, or 200° C. or lower. The expansion initiation temperature of the first hollow particles 111 means, in a temperature (axis of abscissa)—volume change (axis of ordinate) profile obtained when temperature is increased at a temperature increase rate of 10° C./min in thermomechanical analysis (TMA), the temperature at an intersection point between the tangent line at a point where a volumetric change of 3 times or more/5° C. occurs and a straight line (axis of abscissa) where the volumetric change is zero (initial volume).

From the viewpoint that the sheet 10 is more suitably used as a thermal insulation material in the reflow step, the maximum expansion temperature of the first hollow particles 111 is preferably 100° C. or higher, 150° C. or higher, 200° C. or higher, or 210° C. or higher, and is preferably 290° C. or lower, 280° C. or lower, or 270° C. or lower. The maximum expansion temperature of the first hollow particles 111 means the temperature at which the first hollow particles 111 exhibit the above-mentioned maximum volumetric expansion ratio.

From the viewpoint of further suppressing deterioration of the thermal insulation properties of the sheet 10, the content (content at atmospheric pressure and 30° C.; hereinafter, the same) of the first hollow particles 111 is preferably 1% by mass or more, more preferably 2% by mass or more, even more preferably 4% by mass or more, and particularly preferably 5% by mass or more, and is 20% by mass or less or 15% by mass or less, based on the total mass of the thermal insulation layer 11.

From the viewpoint of further suppressing deterioration of the thermal insulation properties of the sheet 10, the content of the first hollow particles 111 is preferably 0.5% by volume or more, more preferably 1.0% by volume or more, and even more preferably 1.5% by volume or more, based on the total volume of the thermal insulation layer 11. From the viewpoint of suppressing excessive expansion of the volume of the sheet 10, the content of the first hollow particles 111 may be 10% by volume or less, 7% by volume or less, 5% by volume or less, or 4% by volume or less, based on the total volume of the thermal insulation layer 11.

The second hollow particles 112 each have an outer shell and a hollow portion. The second hollow particles 112 are organic hollow particles other than the first hollow particles 111. That is, the second hollow particles 112 are organic hollow particles whose maximum volumetric expansion ratio with respect to the volume at 25° C. is less than 10 times. By using the second hollow particles 112, the thermal insulation properties of the thermal insulation layer 11 are improved, and the sheet 10 can be suitably utilized as a thermal insulation material. The maximum volumetric expansion ratio of the second hollow particles 112 is measured by the same method as that for the maximum volumetric expansion ratio of the first hollow particles.

The outer shell of the second hollow particles 112 is composed of an organic material. The outer shell of the second hollow particles 112 is preferably composed of a polymer, and is more preferably composed of a thermoplastic polymer. In this case, the hollow particles are less likely to crack even when pressure is applied, and can retain a hollow structure, and therefore, the thermal insulation properties of the sheet 10 are easily maintained. The thermoplastic polymer may be, for example, a polymer containing acrylonitrile, vinylidene chloride, or the like as a monomer unit. The thickness of the outer shell may be 0.005 μm or more and may be 15 μm or less.

In the hollow portion of the second hollow particles 112, for example, a gas is enclosed. The second hollow particles 112 enclose, for example, a gas at normal temperature and normal pressure (for example, at least at atmospheric pressure and 30° C.). In the hollow portion of the second hollow particles 112, a liquid may be further enclosed in addition to the gas.

Examples of the component enclosed in the hollow portion of the second hollow particles 112 include hydrocarbons such as propane, propylene, butene, normal butane, isobutane, normal pentane, isopentane, neopentane, normal hexane, isohexane, heptane, isooctane, normal octane, isoalkanes (number of carbon atoms: 10 to 13), and petroleum ether; low-boiling point compounds such as methane halides and tetraalkylsilanes; and decomposition products of compounds that are gasified by thermal decomposition, such as azodicarbonamide. Furthermore, the component enclosed in the hollow portion of the second hollow particles 112 may be air.

From the viewpoint of enhancing the thermal insulation properties, the average particle size of the second hollow particles 112 is preferably 150 μm or less, more preferably 120 μm or less, and even more preferably 100 μm or less, and the average particle size may be, for example, 5 μm or more, 10 μm or more, 20 μm or more, or 30 μm or more. The average particle size of the second hollow particles is measured by a laser diffraction and scattering method (for example, using “SALD-7500nano” manufactured by SHIMADZU CORPORATION).

The density of the second hollow particles 112 may be 500 kg/m³ or less, 300 kg/m³ or less, 100 kg/m³ or less, 50 kg/m³ or less, or 40 kg/m³ or less, and may be 10 kg/m³ or more or 20 kg/m³ or more. The density of the second hollow particles 112 according to the present specification means a density measured by a tapped density method. That is, the density is a density determined by introducing the second hollow particles 112 (about 5 g) into a 10-mL graduated cylinder, tapping the graduated cylinder fifty times, and using the volume when the topmost surface is stabilized as the stable volume and using the following formula:

Density=Initial input amount (kg)/stable volume (m³)

From the viewpoint that the sheet 10 is more suitably used as a thermal insulation material in the reflow step (generally heated up to 260° C.), the shrink initiation temperature of the second hollow particles 112 is preferably 150° C. or higher, 170° C. or higher, or 180° C. or higher, and may be 260° C. or lower, 240° C. or lower, 220° C. or lower, or 200° C. or lower. The shrink initiation temperature of the second hollow particles 112 means, in a temperature (axis of abscissa)—volume change (axis of ordinate) profile obtained when temperature is increased at a temperature increase rate of 10° C./min in thermomechanical analysis (TMA), the temperature at which the volume change reaches the maximum value.

From the viewpoint of enhancing the thermal insulation properties of the sheet 10, the content (content at atmospheric pressure and 30° C.; hereinafter, the same) of the second hollow particles 112 is preferably 1% by mass or more, more preferably 3% by mass or more, and even more preferably 5% by mass or more, and may be, for example, 20% by mass or less, based on the total mass of the thermal insulation layer 11.

From the viewpoint of enhancing the thermal insulation properties of the sheet 10, the content of the second hollow particles 112 is preferably 50% by volume or more, and more preferably 60% by volume or more, and may be, for example, 95% by volume or less, based on the total volume of the thermal insulation layer 11.

The mass ratio of the content of the second hollow particles to the content of the first hollow particles (content (mass) of the second hollow particles/content (mass) of the first hollow particles) is preferably ⅕ or more, and more preferably ⅓ or more. The mass ratio of the content of the second hollow particles to the content of the first hollow particles is preferably 3 or less, more preferably 2 or less, and even more preferably 1 or less.

The volume ratio of the content of the second hollow particles to the content of the first hollow particles (content (volume) of the second hollow particles/content (volume) of the first hollow particles) is preferably 10 or more, and more preferably 15 or more. The volume ratio of the content of the second hollow particles to the content of the first hollow particles is preferably 80 or less, more preferably 60 or less, and even more preferably 45 or less.

The thermal insulation layer 11 may further contain inorganic hollow particles. The inorganic hollow particles each have an outer shell and a hollow portion. The outer shell of the inorganic hollow particles is composed of an inorganic material. The inorganic material may be, for example, inorganic glass such as borosilicate glass (sodium borosilicate glass or the like), aluminosilicate glass, or glass obtained by compositizing those. In the hollow portion of the inorganic hollow particles, for example, a gas is enclosed. The inorganic hollow particles enclose, for example, a gas at normal temperature and normal pressure (for example, at least at atmospheric pressure and 30° C.).

The total content of the hollow particles (total content of the first hollow particles 111, the second hollow particles 112, and the inorganic hollow particles at atmospheric pressure and 30° C.; hereinafter, the same) may be, for example, 4% by mass or more, 8% by mass or more, or 10% by mass or more, and may be 40% by mass or less, 35% by mass or less, or 30% by mass or less, based on the total mass of the sheet 10.

The total content of the hollow particles may be, for example, 50% by volume or more, 60% by volume or more, or 70% by volume or more, and may be 95% by volume or less, based on the total volume of the sheet 10.

The matrix polymer 113 is a polymer (binder polymer) that serves as a matrix (forming a continuous phase) for holding other materials contained in the thermal insulation layer 11. The first hollow particles 111 and the second hollow particles 112 are held in the matrix polymer 113 and may be dispersed in the matrix polymer 113.

The matrix polymer 113 may contain a compound represented by the following Formula (1) as a monomer unit. In other words, the matrix polymer 113 may be a polymer of polymerizable compounds containing a compound represented by the following Formula (1).

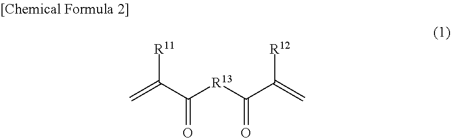

In the Formula (1), R¹¹ and R¹² each independently represent a hydrogen atom or a methyl group; and R¹³ represents a divalent group having a polyoxyalkylene chain.

When the matrix polymer 113 contains a compound represented by the above-described Formula (1) as a monomer unit, the thermal insulation layer 11 has low elasticity and excellent elongation, and therefore, the conformability of the sheet 10 to an adherend can be enhanced.

According to an embodiment, one of R¹¹ and R¹² may be a hydrogen atom, and the other one may be a methyl group. According to another embodiment, both R¹¹ and R¹² may be hydrogen atoms. According to another embodiment, both R¹¹ and R¹² may be methyl groups.

According to an embodiment, the polyoxyalkylene chain contains a structural unit represented by the following Formula (2). As a result, the strength of the thermal insulation layer 11 can be increased.

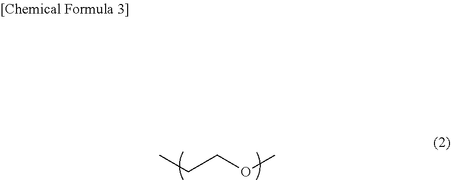

In this case, R¹³ may be a divalent group having a polyoxyethylene chain, and the compound represented by the Formula (1) is preferably a compound represented by the following Formula (1-2) (polyethylene glycol di(meth)acrylate).

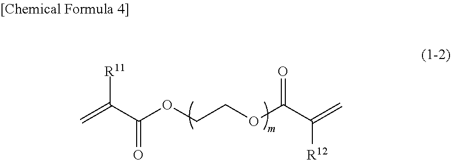

In the Formula (1-2), R¹¹ and R¹² have the same meanings as R¹¹ and R¹² in the Formula (1), respectively, and m is an integer of 2 or greater.

According to another embodiment, the polyoxyalkylene chain contains a structural unit represented by the following Formula (3).

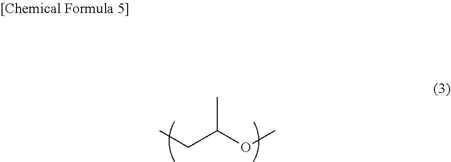

In this case, R¹³ may be a divalent group having a polyoxypropylene chain, and the compound represented by the Formula (1) is preferably a compound represented by the following Formula (1-3) (polypropylene glycol di(meth)acrylate).

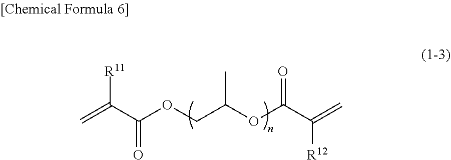

In the Formula (1-3), R¹¹ and R¹² have the same meanings as R¹¹ and R¹² in the Formula (1), respectively, and n is an integer of 2 or greater.

According to another embodiment, the polyoxyalkylene chain is preferably a copolymer chain containing the above-mentioned structural unit represented by the Formula (2) and the above-mentioned structural unit represented by the Formula (3). The copolymer chain may be any of an alternating copolymer chain, a block copolymer chain, or a random copolymer chain. The copolymer chain is preferably a random copolymer chain.

In each of the above-mentioned embodiments, the polyoxyalkylene chain may have an oxyalkylene group having 4 or 5 carbon atoms, such as an oxytetramethylene group, an oxybutylene group, or an oxypentylene group, as a structural unit in addition to the structural unit represented by the Formula (2) and the structural unit represented by the Formula (3).

R¹³ may also be a divalent group further having an additional organic group in addition to the above-mentioned polyoxyalkylene chain. The additional organic group may be a chain-shaped group other than a polyoxyalkylene chain, and examples include a methylene chain (a chain having —CH₂— as a structural unit), a polyester chain (a chain containing —COO— in a structural unit), and a polyurethane chain (a chain containing —OCON— in a structural unit).

For example, the compound represented by the Formula (1) may be a compound represented by the following Formula (1-4).

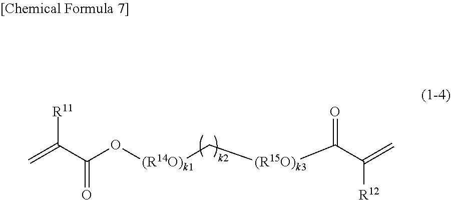

In the Formula (1-4), R¹¹ and R¹² have the same meanings as R¹¹ and R¹² in the Formula (1), respectively; R¹⁴ and R¹⁵ each independently represent an alkylene group having 2 to 5 carbon atoms; and k1, k2, and k3 each independently represent an integer of 2 or greater. k2 may be, for example, an integer of 16 or less.

A plurality of R¹⁴ and a plurality of R¹⁵ present therein may be respectively identical to each other or may be different from each other. A plurality of R¹⁴ and a plurality of R¹⁵ present therein each preferably contain an ethylene group and a propylene group. That is, each of the polyoxyalkylene chain represented by (R¹⁴O)ₖ₁ and the polyoxyalkylene chain represented by (R⁵)ₖ₃ is preferably a copolymer chain containing an oxyethylene group (the above-described structural unit represented by the Formula (2)) and an oxypropylene group (the above-described structural unit represented by the Formula (3)).

In each of the above-mentioned embodiments, the number of oxyalkylene groups in the polyoxyalkylene chain is preferably 100 or greater. When the number of oxyalkylene groups in the polyoxyalkylene chain is 100 or greater, as the main chain of the compound represented by the Formula (1) is lengthened, the elongation of the thermal insulation layer 11 is more excellent, and the strength of the thermal insulation layer 11 can also be increased. The number of oxyalkylene groups corresponds to each of m in the Formula (1-2), n in the Formula (1-3), and k1 and k3 in the Formula (1-4).

The number of oxyalkylene groups in the polyoxyalkylene chain is more preferably 130 or greater, 180 or greater, 200 or greater, 220 or greater, 250 or greater, 270 or greater, 300 or greater, or 320 or greater. The number of oxyalkylene groups in the polyoxyalkylene chain may be 600 or less, 570 or less, or 530 or less.

From the viewpoint that the thermal insulation layer 11 has low elasticity and excellent elongation, the weight average molecular weight of the compound represented by the Formula (1) is preferably 5000 or more, 6000 or more, 7000 or more, 8000 or more, 9000 or more, 10000 or more, 11000 or more, 12000 or more, 13000 or more, 14000 or more, or 15000 or more. The weight average molecular weight of the compound represented by the Formula (1) is preferably 100000 or less, 80000 or less, 60000 or less, 34000 or less, 31000 or less, or 28000 or less.

The matrix polymer 113 may contain only the compound represented by the Formula (1) as the monomer unit. The matrix polymer 113 may further contain an additional polymerizable compound (the details will be described below) other than the compound represented by the Formula (1), as a monomer unit. In this case, from the viewpoint that the thermal insulation layer 11 has lower elasticity and more excellent elongation, the content of the compound represented by the Formula (1) is preferably 20 parts by mass or more, 30 parts by mass or more, or 40 parts by mass or more, with respect to 100 parts by mass of the sum of the compound represented by the Formula (1) and the additional polymerizable compound (hereinafter, referred to as “total content of the monomer units”). The content of the compound represented by the Formula (1) may be 80 parts by mass or less, 70 parts by mass or less, or 60 parts by mass or less, with respect to 100 parts by mass of the total content of the monomer units.

The additional polymerizable compound (monomer unit) may be, for example, a compound having one (meth)acryloyl group. This compound may be, for example, an alkyl (meth)acrylate. The additional polymerizable compound may also be a compound having, in addition to the one (meth)acryloyl group, an aromatic hydrocarbon group, a group containing a polyoxyalkylene chain, a group containing a heterocyclic ring, an alkoxy group, a phenoxy group, a group containing a silane group, a group containing a siloxane bond, a halogen atom, a hydroxyl group, a carboxyl group, an amino group, or an epoxy group. Particularly, when the matrix polymer 113 contains a compound having a hydroxyl group, a carboxyl group, an amino group, or an epoxy group in addition to a (meth)acryloyl group, the adhesiveness of the thermal insulation layer 11 to other members can be further improved.

The alkyl group (alkyl group moiety other than the (meth)acryloyl group) in the alkyl (meth)acrylate may be linear, branched, or cyclic. The number of carbon atoms of the alkyl group may be, for example, 1 to 30. The number of carbon atoms of the alkyl group may be 1 to 11, 1 to 8, 1 to 6, or 1 to 4 and may be 12 to 30, 12 to 28, 12 to 24, 12 to 22, 12 to 18, or 12 to 14.

Examples of an alkyl (meth)acrylate having a linear alkyl group include an alkyl (meth)acrylate having a linear alkyl group having 1 to 11 carbon atoms, and an alkyl (meth)acrylate having a linear alkyl group having 12 to 30 carbon atoms.

Examples of the alkyl (meth)acrylate having a linear alkyl group having 1 to 11 carbon atoms include methyl (meth)acrylate, ethyl (meth)acrylate, propyl (meth)acrylate, butyl (meth)acrylate, pentyl (meth)acrylate, n-hexyl (meth)acrylate, n-heptyl (meth)acrylate, octyl (meth)acrylate, nonyl (meth)acrylate, decyl (meth)acrylate, and undecyl (meth)acrylate.

Examples of the alkyl (meth)acrylate having a linear alkyl group having 12 to 30 carbon atoms include dodecyl (meth)acrylate (lauryl (meth)acrylate), tetradecyl (meth)acrylate, hexadecyl (meth)acrylate (cetyl (meth)acrylate), octadecyl (meth)acrylate (stearyl (meth)acrylate), docosyl (meth)acrylate (behenyl (meth)acrylate), tetracosyl (meth)acrylate, hexacosyl (meth)acrylate, and octacosyl (meth)acrylate.

Examples of an alkyl (meth)acrylate having a branched alkyl group include an alkyl (meth)acrylate having a branched alkyl group having 1 to 11 carbon atoms, and an alkyl (meth)acrylate having a branched alkyl group having 12 to 30 carbon atoms.

Examples of the alkyl (meth)acrylate having a branched alkyl group having 1 to 11 carbon atoms include s-butyl (meth)acrylate, t-butyl (meth)acrylate, isobutyl (meth)acrylate, isopentyl (meth)acrylate, isoamyl (meth)acrylate, isooctyl (meth)acrylate, 2-ethylhexyl (meth)acrylate, isononyl (meth)acrylate, and isodecyl (meth)acrylate.

Examples of the alkyl (meth)acrylate having a branched alkyl group having 12 to 30 carbon atoms include isomyristyl (meth)acrylate, 2-propylheptyl (meth)acrylate, isoundecyl (meth)acrylate, isododecyl (meth)acrylate, isotridecyl (meth)acrylate, isopentadecyl (meth)acrylate, isohexadecyl (meth)acrylate, isoheptadecyl (meth)acrylate, isostearyl (meth)acrylate, and decyltetradecanyl (meth)acrylate.

Examples of an alkyl (meth)acrylate having an alicyclic (cyclic) alkyl group (cycloalkyl group) include cyclohexyl (meth)acrylate, 3,3,5-trimethylcyclohexyl (meth)acrylate, isobornyl (meth)acrylate, terpene(meth)acrylate, and dicyclopentanyl (meth)acrylate.

Examples of a compound having a (meth)acryloyl group and an aromatic hydrocarbon group include benzyl (meth)acrylate.

Examples of a compound having a (meth)acryloyl group and a group containing a polyoxyalkylene chain include polyethylene glycol (meth)acrylate, methoxy polyethylene glycol (meth)acrylate, polypropylene glycol (meth)acrylate, methoxy polypropylene glycol (meth)acrylate, polybutylene glycol (meth)acrylate, and methoxy polybutylene glycol (meth)acrylate.

Examples of a compound having a (meth)acryloyl group and a group containing a heterocyclic ring include tetrahydrofurfuryl (meth)acrylate.

Examples of a compound having a (meth)acryloyl group and an alkoxy group include 2-methoxyethyl acrylate.

Examples of a compound having a (meth)acryloyl group and a phenoxy group include phenoxyethyl (meth)acrylate.

Examples of a compound having a (meth)acryloyl group and a group containing a silane group include 3-acryloxypropyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

Examples of a compound having a (meth)acryloyl group and a group containing a siloxane bond include silicone (meth)acrylate.

Examples of a compound having a (meth)acryloyl group and a halogen atom include (meth)acrylates having fluorine atoms, such as trifluoromethyl (meth)acrylate, 2,2,2-trifluoroethyl (meth)acrylate, 1,1,1,3,3,3-hexafluoro-2-propyl (meth)acrylate, perfluoroethylmethyl (meth)acrylate, perfluoropropylmethyl (meth)acrylate, perfluorobutylmethyl (meth)acrylate, perfluoropentylmethyl (meth)acrylate, perfluorohexylmethyl (meth)acrylate, perfluoroheptylmethyl (meth)acrylate, perfluorooctylmethyl (meth)acrylate, perfluorononylmethyl (meth)acrylate, perfluorodecylmethyl (meth)acrylate, perfluoroundecylmethyl (meth)acrylate, perfluorododecylmethyl (meth)acrylate, perfluorotridecylmethyl (meth)acrylate, perfluorotetradecylmethyl (meth)acrylate, 2-(trifluoromethyl)ethyl (meth)acrylate, 2-(perfluoroethyl)ethyl (meth)acrylate, 2-(perfluoropropyl)ethyl (meth)acrylate, 2-(perfluorobutyl)ethyl (meth)acrylate, 2-(perfluoropentyl)ethyl (meth)acrylate, 2-(perfluorohexyl)ethyl (meth)acrylate, 2-(perfluoroheptyl)ethyl (meth)acrylate, 2-(perfluorooctyl)ethyl (meth)acrylate, 2-(perfluorononyl)ethyl (meth)acrylate, 2-(perfluorotridecyl)ethyl (meth)acrylate, and 2-(perfluorotetradecyl)ethyl (meth)acrylate.

Examples of a compound having a (meth)acryloyl group and a hydroxyl group include a hydroxyalkyl (meth)acrylate and a hydroxyalkylcycloalkane (meth)acrylate. Examples of the hydroxyalkyl (meth)acrylate include 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, and 12-hydroxylauryl (meth)acrylate. Examples of the hydroxyalkylcycloalkane (meth)acrylate include (4-hydroxymethylcyclohexyl)methyl (meth)acrylate.

Examples of a compound having a (meth)acryloyl group and a carboxyl group include (meth)acrylic acid, carboxyethyl (meth)acrylate, carboxypentyl (meth)acrylate, phthalic acid monohydroxyethyl acrylate (for example, “ARONIX M5400” manufactured by TOAGOSEI CO., LTD.), and 2-acryloyloxyethyl succinate (for example, “NK ESTER A-SA” manufactured by SHIN-NAKAMURA CHEMICAL Co., Ltd.).

Examples of a compound having a (meth)acryloyl group and an amino group include N,N-dimethylaminoethyl (meth)acrylate, N,N-diethylaminoethyl (meth)acrylate, N,N-dimethylaminopropyl (meth)acrylate, and N,N-diethylaminopropyl (meth)acrylate.

Examples of a compound having a (meth)acryloyl group and an epoxy group include glycidyl (meth)acrylate, glycidyl α-ethyl (meth)acrylate, glycidyl α-n-propyl (meth)acrylate, glycidyl α-n-butyl (meth)acrylate, 3,4-epoxybutyl (meth)acrylate, 4,5-epoxypentyl (meth)acrylate, 6,7-epoxyheptyl (meth)acrylate, 6,7-epoxyheptyl α-ethyl (meth)acrylate, 3-methyl-3,4-epoxybutyl (meth)acrylate, 4-methyl-4,5-epoxypentyl (meth)acrylate, 5-methyl-5,6-epoxyhexyl (meth)acrylate, β-methylglycidyl (meth)acrylate, and β-methylglycidyl α-ethyl (meth)acrylate.

The matrix polymer 113 may contain one kind of the above-described additional polymerizable compounds, or may contain two or more kinds thereof, as a monomer unit. Furthermore, the matrix polymer 113 may or may not further contain the compound represented by the Formula (1).

The content of the matrix polymer 113 may be, for example, 40% by mass or more, 50% by mass or more, 60% by mass or more, or 70% by mass or more, and may be 95% by mass or less, or 90% by mass or less, based on the total mass of the thermal insulation layer 11.

The thermal insulation layer 11 may further contain additional additives as necessary. Examples of the additional additives include a plasticizer, an antioxidant (for example, a phenol-based antioxidant), a surface conditioning agent (for example, a silane coupling agent), a dispersant, a curing accelerator, a colorant, a crystal nucleating agent, a thermal stabilizer, a foaming agent, a flame retardant, a damping agent, a dehydrating agent, and a flame retardant aid (for example, a metal oxide). The content of the additional additives may be 0.1% by mass or more and may be 30% by mass or less, based on the total mass of the thermal insulation layer 11.

The thickness of the thermal insulation layer 11 may be, for example, 100 μm or more, 200 μm or more, or 500 μm or more, and may be 10 mm or less, 5 mm or less, or 2 mm or less.

The adhesive layer 12 may contain a known adhesive agent. The adhesive layer 12 may contain an acrylic adhesive, an epoxy-based adhesive, or the like. The acrylic adhesive may contain, for example, an acrylic copolymer and a crosslinking agent.

The acrylic copolymer is a copolymer of two or more kinds of polymerizable compounds. The two or more kinds of polymerizable compounds contain one or more kinds of a compound having a (meth)acryloyl group. The acrylic copolymer contains one or more kinds of a compound having a (meth)acryloyl group as a monomer unit; and the acrylic copolymer may contain two or more kinds, three or more kinds, or four or more kinds of the compound having a (meth)acryloyl group as a monomer unit.

The compound having a (meth)acryloyl group may be, for example, an alkyl (meth)acrylate. The alkyl group (alkyl group moiety other than the (meth)acryloyl group) in the alkyl (meth)acrylate may be linear, branched, or cyclic. The number of carbon atoms of the alkyl group may be, for example, 1 to 30. The number of carbon atoms of the alkyl group may be 2 or more, or 3 or more, and may be 25 or less, 20 or less, 15 or less, 10 or less, 7 or less, or 5 or less.

Examples of the compound having a (meth)acryloyl group include an alkyl (meth)acrylate having a linear alkyl group having 1 to 11 carbon atoms, an alkyl (meth)acrylate having a branched alkyl group having 1 to 11 carbon atoms, a compound having a (meth)acryloyl group and a group containing a heterocyclic ring, a compound having a (meth)acryloyl group and a hydroxyl group, and a compound having a (meth)acryloyl group and a carboxyl group.

Examples of the alkyl (meth)acrylate having a linear alkyl group having 1 to 11 carbon atoms include methyl (meth)acrylate and butyl (meth)acrylate. Examples of the alkyl (meth)acrylate having a branched alkyl group having 1 to 11 carbon atoms include 2-ethylhexyl (meth)acrylate. Examples of the compound having a (meth)acryloyl group and a group containing a heterocyclic ring include N-acryloylmorpholine (ACMO). Examples of the compound having a (meth)acryloyl group and a hydroxyl group include 2-hydroxyethyl (meth)acrylate. Examples of the compound having a (meth)acryloyl group and a carboxyl group include (meth)acrylic acid.

The acrylic copolymer may contain an additional polymerizable compound other than the compound having a (meth)acryloyl group, as a monomer unit. Examples of the additional polymerizable compound (monomer unit) in the acrylic copolymer include acrylonitrile.

The weight average molecular weight (Mw) of the acrylic copolymer may be 100000 or more, 200000 or more, 400000 or more, 500000 or more, or 600000 or more, and may be 1200000 or less, 1100000 or less, or 1000000 or less.

The content of the acrylic copolymer may be 70% by mass or more or 80% by mass or more, and may be 98% by mass or less or 95% by mass or less, based on the total mass of the adhesive layer 12.

The crosslinking agent may be, for example, a crosslinking agent having an epoxy group, or a crosslinking agent having an isocyanate group. The crosslinking agent having an epoxy group may have two or more, three or more, or four or more epoxy groups.

Examples of a crosslinking agent having four epoxy groups include N,N,N′,N′-tetraglycidyl-1,3-bis(aminomethyl)cyclohexane, and N,N,N′,N′-tetraglycidyl-m-xylenediamine.

The crosslinking agent having an isocyanate group may have two or more isocyanate groups or three or more isocyanate groups. Examples of the crosslinking agent having three isocyanate groups include “CORONATE L” (manufactured by Tosoh Corporation).

The thickness of the adhesive layer 12 may be, for example, 5 μm or more or 10 μm or more, and may be 200 μm or less, 100 μm or less, or 50 μm or less.

The sheet 10 may consist of the thermal insulation layer 11 and the adhesive layer 12, as in the embodiment shown in FIG. 1. According to another embodiment, the sheet may further include a layer other than the thermal insulation layer and the adhesive layer. In this case, in the sheet, the thermal insulation layer and the adhesive layer may be in contact with each other (may be laminated without any other layer interposed therebetween), or the thermal insulation layer and the adhesive layer may be laminated with an additional layer interposed therebetween. Examples of the additional layer include a surface protective layer, a bonding adhesive layer, and a support layer.

According to one embodiment, a sheet including another layer may be a sheet including a surface protective layer (first surface protective layer), a thermal insulation layer, a bonding adhesive layer (first bonding adhesive layer), a support layer (first support layer), a bonding adhesive layer (second bonding adhesive layer), a support layer (second support layer), an adhesive layer, and a surface protective layer (second surface protective layer). The surface protective layer may be composed of, for example, a resin film (PET film or the like) whose surface that comes into contact with the thermal insulation layer or the adhesive layer has been easy-release treated. The bonding adhesive layer may contain, for example, an acrylic bonding adhesive or an epoxy-based bonding adhesive. The support layer may be composed of, for example, a resin film (polyimide film or the like).

The thickness of the sheet 10 may be, for example, 100 μm or more, 200 μm or more, or 500 μm or more, and may be 11 mm or less, 5 mm or less, 3 mm or less, or 2 mm or less.

The sheet 10 can be produced by, for example, producing each of the thermal insulation layer 11 and the adhesive layer 12, and sticking the thermal insulation layer 11 and the adhesive layer 12 together. For example, a method for manufacturing the above-described sheet including an additional layer may include: a step of preparing each of a laminated body A of a surface protective layer (first surface protective layer) and a thermal insulation layer, a laminated body B of a bonding adhesive layer (first bonding adhesive layer), a support layer (first support layer), and a bonding adhesive layer (second bonding adhesive layer), and a laminated body C of a support layer (second support layer), an adhesive layer, and a surface protective layer (second surface protective layer); and a step of sticking the thermal insulation layer of the laminated body A and the bonding adhesive layer (first bonding adhesive layer) of the laminated body B together and sticking the bonding adhesive layer (second bonding adhesive layer) of the laminated body B and the support layer (second support layer) of the laminated body C.

The laminated body A is obtained by, for example, preparing a mixture containing the above-mentioned first hollow particles, the second hollow particles, and the polymerizable compound, and then polymerizing the polymerizable compound in the mixture on a surface protective layer (first surface protective layer) to form a matrix polymer. As the laminated body B, for example, a double-sided bonding adhesive tape including: a support layer (first support layer); and a bonding adhesive layer (first bonding adhesive layer) and a bonding adhesive layer (second bonding adhesive layer) respectively provided on the two surfaces of the support layer, can be used. The laminated body C is obtained by, for example, applying an adhesive composition obtained by mixing materials such as an acrylic adhesive, on a surface protective layer (second surface protective layer), proceeding drying of the adhesive composition and/or curing of curable components in the adhesive composition to form an adhesive layer, and then providing a support layer (second support layer) on a surface of the adhesive layer on the opposite side from the surface protective layer (second surface protective layer). In the step of sticking the laminated body A, the laminated body B, and the laminated body C together, for example, a roll laminator can be used.

### EXAMPLES

Hereinafter, the present invention will be described more specifically based on Examples; however, the present invention is not intended to be limited to these Examples.

### <Thermal Insulation Layer>

In order to produce a thermal insulation layer, each of the following components was used.

### (First Hollow Particles)

A: “MATSUMOTO MICROSPHERE FN-190SSD” manufactured by Matsumoto Yushi-Seiyaku Co., Ltd. (average particle size: 10 to 15 μm, maximum volumetric expansion ratio: 50 times or more, expansion initiation temperature: 190° C., maximum expansion temperature: 210 to 220° C.)

### (Second Hollow Particles)

B: “Expancel 920DE80d30” manufactured by Japan Fillite Co., Ltd. (average particle size 60 to 90 μm, density 30±3 kg/m³, maximum volumetric expansion ratio: less than 5 times, shrink initiation temperature: 200° C.)

### (Polymerizable Compound)

C-1: Compound represented by the following Formula (1-5) synthesized by the procedure described below (weight average molecular weight: 15000, a mixture in which m1+m2 in the Formula (1-5) represents an integer of approximately 252±5, n1+n2 represents an integer of approximately 63±5 (provided that m1, m2, n1, and n2 are each an integer of 2 or greater, m1+n1≥100, and m2+n2≥100))

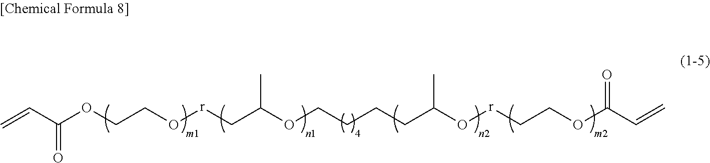

[in the Formula (1-5), -r- is a symbol representing random copolymerization.]
C-2: Dicyclopentanyl acrylate (“FANCRYL FA-513A” manufactured by Showa Denko Materials Co., Ltd.)
C-3: 4-Hydroxybutyl acrylate (manufactured by OSAKA ORGANIC CHEMICAL INDUSTRY LTD.)

### (Other Components)

D: Polymerization initiator (“PERBUTYL O” manufactured by NOF CORPORATION)
E: Phenol-based antioxidant (“Irganox 1010” manufactured by BASF Japan Ltd.)
F: Surface conditioning agent (“BYK 350” manufactured by BYK)

### [Synthesis of Compound Represented by the Formula (1-5)]

A 500-mL flask equipped with a stirrer, a thermometer, a nitrogen gas inlet tube, a discharge tube, and a heating jacket was used as a reactor, 225 g of a glycol having a polyoxyalkylene chain (“NEWPOL 75H-90000” manufactured by Sanyo Chemical Industries, Ltd.) and 300 g of toluene were introduced into the reactor, the mixture was stirred at 45° C. and a speed of stirring rotation of 250 times/min, nitrogen was allowed to flow at a rate of 100 mL/min, and the mixture was stirred for 30 minutes. Subsequently, the temperature was lowered to 25° C., and after completion of the temperature lowering, 2.9 g of acryloyl chloride was added dropwise into the reactor, followed by stirring for 30 minutes. Subsequently, 3.8 g of triethylamine was added dropwise, and the mixture was stirred for 2 hours. Subsequently, the temperature was raised to 45° C., and the mixture was allowed to react for 2 hours. The reaction liquid was filtered, the filtrate was desolvated, and a compound represented by the Formula (1-5) was obtained.

### [Production of Thermal Insulation Layer]

Each of the components in the amounts indicated in Table 1 was mixed, and a composition for producing a thermal insulation layer was obtained. Two sets of molding plates were prepared by placing a mold release-treated polyester sheet (“A31” manufactured by TOYOBO CO., LTD.) that measured 200 mm in length×200 mm in width×0.1 mm in thickness on a glass plate that measured 200 mm in length×200 mm in width×5 mm in thickness, with the mold release-treated surface facing upward. A formwork (200 mm×200 mm) made of silicone rubber, in which a hole having a size of 120 mm×120 mm×2.0 mm was formed, was installed on the mold release-treated surface of one of the molding plates, and the inside of the formwork was filled with the composition for producing a thermal insulation layer. The other molding plate was placed, with the mold release-treated surface facing the composition side, to serve as a top lid, and then the composition was heated for 40 minutes under the conditions of 135° C. Thereafter, one of the molding plates, the formwork made of silicone rubber, and the glass plate on the other molding plate were removed, and a laminated body (laminated body A) of a surface protective layer (polyester sheet) and a thermal insulation layer (thickness 2.0 mm) was produced. Furthermore, the thermal insulation layer was obtained by peeling the surface protective layer of the laminated body A.

### [Evaluation of Thermal Insulation Properties]

The thermal conductivity of the thermal insulation layer used in each of Examples and Comparative Examples was measured by the following procedure. The thermal insulation layer was cut into a size of 8 cm×13 cm×2.0 mm and was sandwiched between a reference plate and a measurement probe, and the thermal conductivity (initial thermal conductivity) was measured with a rapid thermal conductivity meter (“QTM-710” manufactured by Kyoto Electronics Manufacturing Co., Ltd., measurement probe PD-11N, thin film measurement mode) under the conditions of 25° C. Furthermore, the thermal insulation layer was cut into a size of 20 mm in width×50 mm in length to produce a test piece of the thermal insulation layer, the test piece was passed through a reflow furnace (TNP25-337 EM series N2 reflow apparatus manufactured by TAMURA CORPORATION) to apply a thermal history, and after the test piece was left to cool, the thermal conductivity (thermal conductivity after heating) was measured as described above. Specifically, the thermal history was applied by increasing the temperature from room temperature (25° C.) to 200° C. at a temperature increase rate of 47° C./min and then increasing the temperature from 200 to 260° C. at a temperature increase rate of 38° C./min in the reflow furnace. Furthermore, when left to cool, specifically, the test piece was cooled to 60° C. in the reflow furnace, taken out from the reflow furnace, and cooled to 25° C. The reference was measured by stacking two sheets of a mold release-treated polyester sheet (“A31” manufactured by TOYOBO CO., LTD.) and sandwiching the sheets between a reference plate and a measurement probe. The results are shown in Table 1.

### [Volume Change Ratio of Thermal Insulation Layer]

A produced thermal insulation layer was cut into a rectangular parallelepiped shape that measured 2 cm×6 cm×0.2 cm (volume: 2.4 cm³) to produce a test piece, a thermal history was applied to the test piece in the same manner as in the above-described [Evaluation of thermal insulation properties] using a reflow furnace, and the test piece was left to cool. Thereafter, the thickness of the test piece was measured at five points using a micrometer to calculate the average value of the thicknesses, and the width of the test piece was measured at five points using a vernier caliper to calculate the average value of the widths. Furthermore, the length of the test piece at one point was measured using a vernier caliper. Using the obtained values, the volume after heating was calculated by the following formula.

Volume after heating[cm³]=(Average value of the thicknesses)×(average value of the widths)×(measured value of length)

In addition, the volume change ratio was determined by the following formula. The results are shown in Table 1.

$$Volume change ratio [ \% ] = \{ ( ( Volume after heating [ {cm}^{3} ] ) - 2.4 ) / 2.4 \} \times 100$$

### <Adhesive Layer>

In each of the Examples and Comparative Examples, any one of adhesive layers a to e produced by the following procedure was used.

[Production of Adhesive Layer a]

An acrylic copolymer (weight average molecular weight: 200000) containing 2-ethylhexyl acrylate (EHA) and 2-hydroxyethyl acrylate (HEA) as monomer units at a ratio of EHA:HEA=65:35 on a mass basis, was used. 100 parts by mass of an ethyl acetate solution (solid content 35% by mass) of this acrylic copolymer, 5 parts by mass of an isocyanate (trade name: CORONATE L, manufactured by Tosoh Corporation) as a crosslinking agent, 7 parts by mass of a decafunctional urethane acrylate (trade name: U-10PPA, manufactured by SHIN-NAKAMURA CHEMICAL Co., Ltd.) as a photocurable resin, and 0.21 parts by mass of a photopolymerization initiator (trade name: Irgcure 819, manufactured by BASF) were dissolved in a mixed solvent of toluene and methyl ethyl ketone such that the solid content was 25% by mass. Next, the mixture was stirred in a rotation-revolution mixer for 5 minutes at a speed of rotation of 1000 rpm, and then was left to stand at normal temperature until all air bubbles disappeared, to obtain an adhesive composition.

The obtained adhesive composition was applied on an easy-release treated surface of a polyester film (trade name: PUREX A31, manufactured by TOYOBO CO., LTD.) having a thickness of 38 μm, whose one surface had been subjected to an easy-release treatment with a silicone-based release agent, and then dried in a drying oven at 100° C. for 2 minutes, and the photocurable resin was cured by irradiating the adhesive composition with ultraviolet radiation having a wavelength of 365 nm at a dose of 300 mJ/cm², to form an adhesive layer having a thickness of 10 μm. Next, by laminating a polyimide film base material (trade name: KAPTON 100H, manufactured by DU PONT-TORAY CO., LTD.) having a thickness of 25 μm on the exposed surface of the formed adhesive layer at room temperature (25° C.), a laminated body in which a surface protective layer (polyester film), an adhesive layer a, and a support layer (polyimide film base material) were laminated in this order (laminated body C including the adhesive layer a) was produced. Furthermore, a support layer-attached adhesive layer a was obtained by peeling the surface protective layer of the laminated body C including the adhesive layer a.

[Production of Adhesive Layer b]

A laminated body C including an adhesive layer b, and a support layer-attached adhesive layer b were produced in the same manner as in the case of the adhesive layer a, except that an acrylic copolymer (weight average molecular weight: 200000) containing methyl acrylate (MA), 2-ethylhexyl acrylate (EHA), acrylic acid (AA), and 2-hydroxyethyl acrylate (HEA) as monomer units at a ratio of MA:EHA:AA:HEA=50:40:0.5:9.5 on a mass basis was used instead of the above-described acrylic copolymer.

[Production of Adhesive Layer c]

A laminated body C including an adhesive layer c, and a support layer-attached adhesive layer c were produced in the same manner as in the case of the adhesive layer b, except that the amount of the isocyanate as a crosslinking agent was changed to 2.4 parts by mass.

[Production of Adhesive Layer d]

An acrylic copolymer (weight average molecular weight: 670000 to 950000) containing butyl acrylate (BA), acrylonitrile (AN), and acrylic acid (AA) as monomer units at a ratio of BA:AN:AA=85:7.5:7.5 on a mass basis, was prepared. This acrylic copolymer, “TETRAD X” manufactured by MITSUBISHI GAS CHEMICAL COMPANY, INC. as a crosslinking agent, “NONFLEX DCD” (4,4-bis(α,α-dimethylbenzyl)diphenylamine) manufactured by Seiko Chemical Co., Ltd. as an antioxidant, and toluene and methyl ethyl ketone (MEK) as solvents were used. These components were mixed at a ratio of acrylic copolymer:crosslinking agent:antioxidant toluene:MEK=80.62:8.47:0.60:8.25:2.06 on a mass basis, and the mixture was stirred in a rotation-revolution mixer for 5 minutes at a speed of rotation of 1000 rpm, and then was left to stand at normal temperature until all air bubbles disappeared, to obtain an adhesive composition. The obtained adhesive composition was applied on an easy-release treated surface of a polyester film (trade name: PUREX A31, manufactured by TOYOBO CO., LTD.) having a thickness of 38 μm, whose one surface had been subjected to an easy-release treatment with a silicone-based release agent, and then dried in a drying oven at 100° C. for 2 minutes, to form an adhesive layer having a thickness of 10 μm. Next, by laminating a polyimide film base material (trade name: KAPTON 100H, manufactured by DU PONT-TORAY CO., LTD.) having a thickness of 25 μm on the exposed surface of the formed adhesive layer at room temperature (25° C.), a laminated body in which a surface protective layer (polyester film), an adhesive layer d, and a support layer (polyimide film base material) were laminated in this order (laminated body C including the adhesive layer d) was produced. Furthermore, a support layer-attached adhesive layer d was obtained by peeling the surface protective layer of the laminated body C including the adhesive layer d.

[Production of Adhesive Layer e]

An acrylic copolymer containing butyl acrylate (BA) and acryloylmorpholine (ACMO) as monomer units at a ratio of BA:ACMO=99.9:0.1 on a mass basis, was prepared. This acrylic copolymer, 1,3-bis(diglycidylaminomethyl)cyclohexane as a crosslinking agent, “NONFLEX DCD” (4,4-bis(α,α-dimethylbenzyl)diphenylamine) manufactured by Seiko Chemical Co., Ltd. as an antioxidant, and ethyl acetate as a solvent were used. These components were mixed at a ratio of acrylic copolymer:crosslinking agent:antioxidant:ethyl acetate=43.41:1.18:0.59:54.82 on a mass basis, and the mixture was stirred in a rotation-revolution mixer for 5 minutes at a speed of rotation of 1000 rpm, and then was left to stand at normal temperature until all air bubbles disappeared, to obtain an adhesive composition. The obtained adhesive composition was applied on an easy-release treated surface of a polyester film (trade name: PUREX A31, manufactured by TOYOBO CO., LTD.) having a thickness of 38 μm, whose one surface had been subjected to an easy-release treatment with a silicone-based release agent, and then dried in a drying oven at 100° C. for 2 minutes, to form an adhesive layer having a thickness of 10 μm. Next, by laminating a polyimide film base material (trade name: KAPTON 100H, manufactured by DU PONT-TORAY CO., LTD.) having a thickness of 25 μm on the exposed surface of the formed adhesive layer at room temperature (25° C.), a laminated body in which a surface protective layer (polyester film), an adhesive layer e, and a support layer (polyimide film base material) were laminated in this order (laminated body C including the adhesive layer e) was produced. Furthermore, a support layer-attached adhesive layer e was obtained by peeling the surface protective layer of the laminated body C including the adhesive layer e.

### [Peel Strength of Adhesive Layer]

The peel strength of each of the adhesive layers a to e was measured by the following procedure. A Si wafer that measured 25 mm in length×70 mm in width and a support layer-attached adhesive layer cut into a size of 20 mm in length×60 mm in width were prepared. The support layer-attached adhesive layer was installed on the Si wafer such that the adhesive layer and the Si wafer were in contact with each other, and no air bubbles were trapped between the two. The Si wafer on which the support layer-attached adhesive layer was installed was placed on a stainless steel plate that measured 380 mm in length×500 mm in width×0.5 mm in thickness, and the adhesive layer and the Si wafer were stuck using a roll laminator (“VA-770H Special Type Laminator” manufactured by TAISEI LAMINATOR CO., LTD.) under the conditions of a pressure of 6 kgf/cm², a speed of rotation of 0.2 rpm, and a temperature of 40° C., to produce a sample. The support layer-attached adhesive layer of the obtained sample was cut to a width of 5 mm, a portion of 10 mm on one side in the length direction was peeled from the Si wafer, and the 90° peel strength (initial 90° peel strength) was measured using a tensile tester (“Autograph EZ-TEST EZ-S” manufactured by SHIMADZU CORPORATION). The results are shown in Table 1.

### <Sheet>

### [Production of Sheet]

Using a roll laminator (HOT DOCK LMP-350EX manufactured by Lami Corporation Inc.), a bonding adhesive tape (tape including a support layer and bonding adhesive layers provided on both surfaces of the support layer, manufactured by Showa Denko Materials Co., Ltd., HI-BON 11-652) was laminated on the support layer side of each of the laminated bodies C including an adhesive layer. In addition, the laminated body A was laminated on the tape using the above-described roll laminator such that the tape and the thermal insulation layer were in contact with each other, to obtain sheets of Examples 1 to 8 and Comparative Examples 1 and 2. The thickness of the sheets was 2135 μm.

TABLE 1

| | | | Comparative | Comparative | Example | Example | Example |
|---|---|---|---|---|---|---|---|
| | | | Example 1 | Example 2 | 1 | 2 | 3 |
| Thermal | Blending amount | A | — | — | 3.0 | 5.8 | 8.5 |
| insulation | (% by mass) | B | 6.5 | 6.5 | 6.3 | 6.1 | 5.9 |
| layer | | C-1 | 44.0 | 44.0 | 42.7 | 41.4 | 40.3 |
| | | C-2 | 26.4 | 26.4 | 25.6 | 24.9 | 24.2 |
| | | C-3 | 17.6 | 17.6 | 17.1 | 16.6 | 16.1 |
| | | D | 1.1 | 1.1 | 1.0 | 1.0 | 1.0 |
| | | E | 3.5 | 3.5 | 3.4 | 3.3 | 3.2 |
| | | F | 0.9 | 0.9 | 0.9 | 0.9 | 0.8 |
| | Blending amount of first hollow | | — | — | 1.0 | 2.0 | 2.9 |
| | particles (% by volume) | | | | | | |
| | Blending amount of second | | 70.0 | 70.0 | 69.3 | 68.6 | 68.0 |
| | hollow particles (% by volume) | | | | | | |
| | Thermal insulation | Initial | 52 | 52 | 52 | 53 | 60 |
| | properties (thermal | After | 103 | 103 | 99 | 72 | 64 |
| | conductivity) | heating | | | | | |
| | (mW/m · K) | | | | | | |
| | Volume change ratio (%) | | −61.3 | −61.3 | −29.0 | −8.5 | 19.1 |
| Adhesive | Type of adhesive layer | | a | b | a | a | a |
| layer | 90° peel strength(N/m) | Initial | 38 | 7 | 38 | 38 | 38 |

| | | | Example | Example | Example | Example | Example |
|---|---|---|---|---|---|---|---|
| | | | 4 | 5 | 6 | 7 | 8 |
| Thermal | Blending amount | A | 11.0 | 11.0 | 11.0 | 11.0 | 11.0 |
| insulation | (% by mass) | B | 5.8 | 5.8 | 5.8 | 5.8 | 5.8 |
| layer | | C-1 | 39.2 | 39.2 | 39.2 | 39.2 | 39.2 |
| | | C-2 | 23.5 | 23.5 | 23.5 | 23.5 | 23.5 |
| | | C-3 | 15.7 | 15.7 | 15.7 | 15.7 | 15.7 |
| | | D | 0.9 | 0.9 | 0.9 | 0.9 | 0.9 |
| | | E | 3.1 | 3.1 | 3.1 | 3.1 | 3.1 |
| | | F | 0.8 | 0.8 | 0.8 | 0.8 | 0.8 |
| | Blending amount of first hollow | | 3.8 | 3.8 | 3.8 | 3.8 | 3.8 |
| | particles (% by volume) | | | | | | |
| | Blending amount of second | | 67.3 | 67.3 | 67.3 | 67.3 | 67.3 |
| | hollow particles (% by volume) | | | | | | |
| | Thermal insulation | Initial | 63 | 63 | 63 | 63 | 63 |
| | properties (thermal | After | 67 | 67 | 67 | 67 | 67 |
| | conductivity) | heating | | | | | |
| | (mW/m · K) | | | | | | |
| | Volume change ratio (%) | | 45.8 | 45.8 | 45.8 | 45.8 | 45.8 |
| Adhesive | Type of adhesive layer | | b | c | a | d | e |
| layer | 90° peel strength(N/m) | Initial | 7 | 5 | 38 | 13 | 23 |

### REFERENCE SIGNS LIST

10: sheet, 11: thermal insulation layer, 12: adhesive layer, 111: first hollow particle, 112: second hollow particle, 113: matrix polymer.

1. A sheet comprising:
a thermal insulation layer; and
an adhesive layer,
wherein the thermal insulation layer comprises first hollow particles being thermally expandable organic hollow particles, second hollow particles being organic hollow particles other than the first hollow particles, and a matrix polymer.

2. The sheet according to claim 1, wherein a content of the first hollow particles is 1.5% by volume or more based on a total volume of the thermal insulation layer.

3. The sheet according to claim 1, wherein a volume ratio of a content of the second hollow particles to a content of the first hollow particles is 45 or less.

4. The sheet according to claim 1 wherein the matrix polymer comprises a compound represented by the following Formula (1) as a monomer unit: 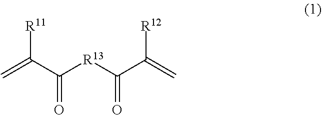
wherein R¹¹ and R¹² each independently represent a hydrogen atom or a methyl group; and R¹³ represents a divalent group having a polyoxyalkylene chain.
